(19) United States
(12) Patent Application Publication
(10) Pub. No.: US 2026/0093019 A1
(43) Pub. Date: Apr. 2, 2026

(54) CALIBRATION SYSTEM, CALIBRATION DEVICE, AND CALIBRATION METHOD

(71) Applicant: NEC Corporation, Tokyo (JP)

(72) Inventors: Tatsuya FUJIMOTO, Tokyo (JP); Junichi ABE, Tokyo (JP); Hidemi NOGUCHI, Tokyo (JP); Kazumine OGURA, Tokyo (JP); Koichi NIHEI, Tokyo (JP)

(73) Assignee: NEC Corporation, Tokyo (JP)

(21) Appl. No.: 19/332,431

(22) Filed: Sep. 18, 2025

(30) Foreign Application Priority Data
Sep. 30, 2024 (JP) 2024-170960

(51) Int. Cl. G01S 7/497; G01S 17/08

(52) U.S. Cl. CPC G01S 7/497; G01S 17/08

(57) ABSTRACT

A calibration system includes a point cloud acquisition unit for acquiring a target sensing point cloud from a target sensing device that measures a distance from a target object for which surveying reliability is ensured, and a calibration unit for calibrating a position and a pose of the target sensing device based on the target sensing point cloud.

### INCORPORATION BY REFERENCE

This application is based upon and claims the benefit of priority from Japanese patent application No. 2024-170960, filed on Sep. 30, 2024, the disclosure of which is incorporated herein in its entirety by reference.

### TECHNICAL FIELD

The present disclosure relates to a calibration system, a calibration device, a calibration method, and a program.

### BACKGROUND ART

JP 2015-127664 A discloses a technique for calibrating a position and a direction of each of a plurality of distance sensors installed in a certain area.

Specifically, a relative positional relationship between a pair of distance sensors is calculated by identifying a commonly observed flow of pedestrians for each pair of distance sensors, and positions and orientations of the plurality of distance sensors are calibrated based on the relative positional relationship.

### SUMMARY

In a configuration of JP 2015-127664 A, there is a problem that the pedestrians who can be observed in common for each pair of distance sensors are required to be present as a prerequisite for calibrating the positions and the orientations of the plurality of distance sensors.

Incidentally, for example, in a case where a road surface of a road is observed at a fixed point using a LiDAR device installed on a side of or above the road and foreign matters on the road surface are detected, it is conceivable to execute coordinate transformation on positions of the foreign matters expressed in the LiDAR coordinate system into a geographic coordinate system and output the geographic coordinate system. Since an installation position and an installation pose of the LiDAR device expressed in the geographic coordinate system are known, it can be said that a coordinate transformation matrix for executing the coordinate transformation from the LiDAR coordinate system to the geographic coordinate system is also known.

However, the installation position and the installation pose of the LiDAR device can constantly change due to environmental factors such as outdoor temperature, vibration, wind, and terrain change. Accordingly, it is required to ascertain deviation amounts from design values of the installation position and the installation pose of the LiDAR device in real time.

In particular, in a case where a distance between the LiDAR device and the foreign matters is 100 meters and it is desired to detect the positions of the foreign matters in units of centimeters, the deviation amount from the design value allowed in the installation pose of the LiDAR device is less than 0.01 degrees, whereby it is required to ascertain the above-described deviation amount with high accuracy.

An example object of the present disclosure is to provide a technique for calibrating a position and a pose of a target sensing device.

According to an example aspect of the present disclosure, provided is a calibration system including a point cloud acquisition means for acquiring a target sensing point cloud from a target sensing device that measures a distance from a target object for which surveying reliability is ensured, and a calibration means for calibrating a position and a pose of the target sensing device based on the target sensing point cloud.

According to an example aspect of the present disclosure, provided is a calibration device including a point cloud acquisition means for acquiring a target sensing point cloud from a target sensing device that measures a distance from a target object for which surveying reliability is ensured, and a calibration means for calibrating a position and a pose of the target sensing device based on the target sensing point cloud.

According to an example aspect of the present disclosure, provided is a calibration method causing a computer to execute acquiring a target sensing point cloud from a target sensing device that measures a distance from a target object for which surveying reliability is ensured, and calibrating a position and a pose of the target sensing device based on the target sensing point cloud.

According to an example aspect of the present disclosure, provided is a program causing a computer to operate as a point cloud acquisition means for acquiring a target sensing point cloud from a target sensing device that measures a distance from a target object for which surveying reliability is ensured, and a calibration means for calibrating a position and a pose of the target sensing device based on the target sensing point cloud.

According to the present disclosure, a position and a pose of a target sensing device can be calibrated.

### BRIEF DESCRIPTION OF DRAWINGS

FIG. 1 is a block diagram of a calibration system;

FIG. 2 is a control flow of the calibration system;

FIG. 3 is a schematic diagram of a road monitoring system;

FIG. 4 is a block diagram of a road monitoring device;

FIG. 5 is a control flow of the road monitoring device;

FIG. 6 is a schematic diagram of a road monitoring system;

FIG. 7 is a schematic diagram of the road monitoring system;

FIG. 8 is a schematic diagram of the road monitoring system; and

FIG. 9 is a block diagram illustrating a hardware configuration of a computer.

### EXAMPLE EMBODIMENT

### Overview of Present Disclosure

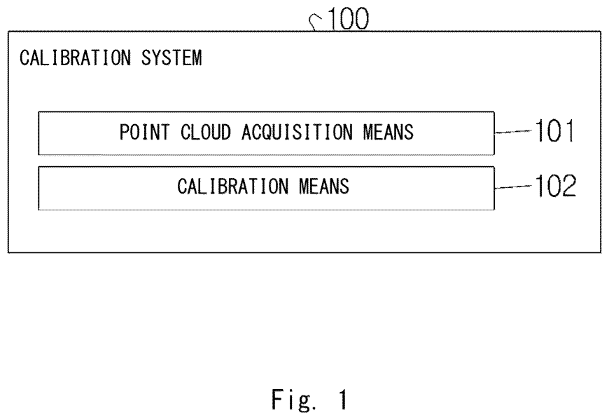

First, an overview of the present disclosure will be described. FIG. 1 is a block diagram of a calibration system 100. The calibration system 100 includes a point cloud acquisition means 101 and a calibration means 102.

The point cloud acquisition means 101 acquires a target sensing point cloud from a target sensing device that measures a distance from a target object for which surveying reliability is ensured.

The calibration means 102 calibrates a position and a pose of the target sensing device based on the target sensing point cloud.

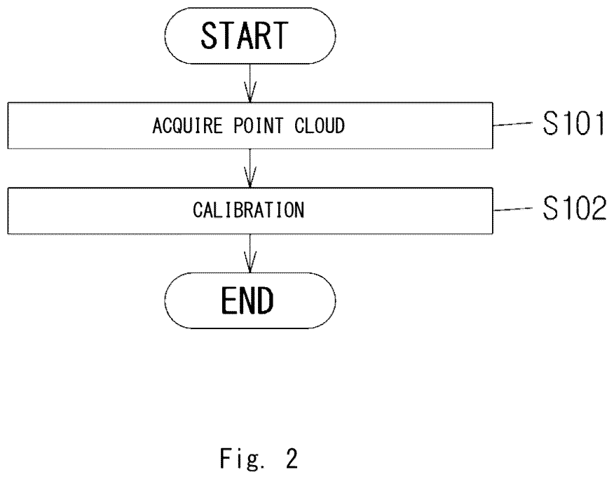

Next, an operation of the calibration system 100 will be described. FIG. 2 is a control flow of the calibration system 100.

First, the point cloud acquisition means 101 acquires the target sensing point cloud from the target sensing device that measures the distance from the target object for which the surveying reliability is ensured (S101). Next, the calibration means 102 calibrates the position and the pose of the target sensing device based on the target sensing point cloud (S102). According to the above configuration, it is possible to calibrate the position and the pose of the target sensing device.

The calibration of the position and the pose of the target sensing device does not mean physical correction of the position and the pose of the target sensing device. The calibration of the position and the pose of the target sensing device typically means ascertainment of a deviation amount from the design values of the position and the pose of the target sensing device or correction of output data of the target sensing device using a calculated deviation amount.

### First Example Embodiment

Next, a road monitoring system according to a first example embodiment of the present disclosure will be described.

Hereinafter, the present disclosure will be described according to the example embodiment of the disclosure, but the disclosure according to the claims is not limited to the following example embodiment. Not all the configurations described in the example embodiment are essential as means for solving the problem. To clarify description, in the following description and drawings, omission and simplification are made as appropriate. In the drawings, the same elements are denoted by the same reference numerals, and repeated description is omitted as necessary.

In the following example embodiments, the description will be divided into a plurality of sections or example embodiments as necessary for convenience, but unless otherwise mentioned, the sections or the embodiments are not irrelevant to each other, and one section or embodiment is in a relationship of a modified example, an application example, a detailed description, a supplementary description, or the like of a part or all of other sections or embodiments. In the following example embodiments, in a case of referring to the number of elements and the like (including a number, a numerical value, an amount, a range, and the like), the number is not limited to a specific number unless otherwise mentioned or clearly limited to the specific number in principle, and the number may be equal to or more than the specific number or may be equal to or less than the specific number.

In the following example embodiments, the components (including operation steps and the like) are not necessarily essential unless otherwise mentioned or considered to be obviously essential in principle. Similarly, in the following example embodiments, in a case where the shapes or the positional relationship of constituents, and the like are referred to, unless otherwise expressly stated or in cases where it is deemed, in principle, clearly not to be so, shapes and the like that are substantially approximate or similar to the described shape are understood to be included. The same applies to the above numbers (including a number, a numerical value, an amount, and a range).

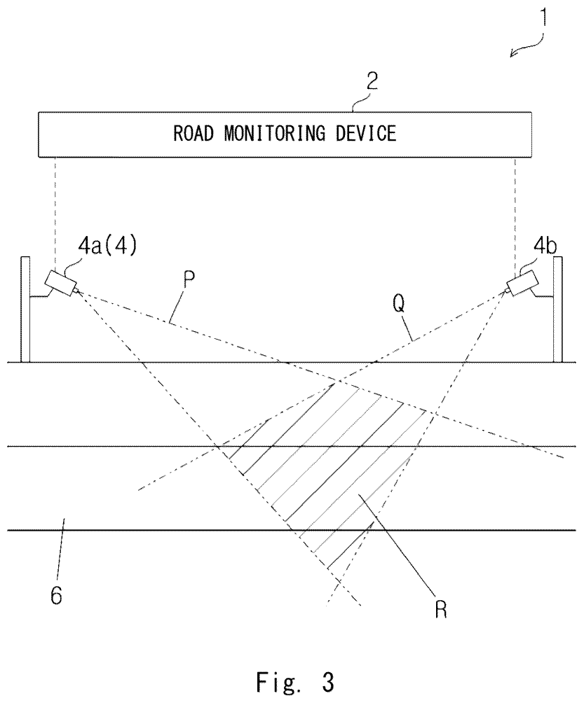

FIG. 3 is a schematic diagram of a road monitoring system 1. The road monitoring system 1 is a specific example of a calibration system. As illustrated in FIG. 3, the road monitoring system 1 includes a road monitoring device 2 and a plurality of fixed point observation devices 4.

The road monitoring device 2 and the plurality of fixed point observation devices 4 typically perform bidirectional communication via a wide area network (WAN) such as the Internet. The plurality of fixed point observation devices 4 are fixedly installed on a side of or above the road 6. Each of the plurality of fixed point observation devices 4 is typically fixed to a column provided on the side of the road 6. The road monitoring device 2 may be implemented by one single device or may be implemented by distributed processing between a plurality of devices.

Each of the fixed point observation devices 4 is a specific example of a sensing device installed to sense the road 6. Each of the fixed point observation devices 4 is a specific example of a fixed point observation sensing device installed to sense the road 6. In the present example embodiment, each of the fixed point observation devices 4 is a light detection and ranging (LiDAR) device. Accordingly, each of the fixed point observation devices 4 generates a three-dimensional point cloud by measuring a distance of a space including a road surface of the road 6, and outputs the generated three-dimensional point cloud to the road monitoring device 2. The three-dimensional point cloud is a specific example of a sensing point cloud.

Instead, each of the fixed point observation devices 4 may be a radio detection and ranging (Radar) device or a stereo camera. Here, each of the fixed point observation devices 4 generates the three-dimensional point cloud by measuring the distance of the space including the road surface of the road 6, and outputs the generated three-dimensional point cloud to the road monitoring device 2.

In the present example embodiment, the plurality of fixed point observation devices 4 include a reference sensing device 4a and a target sensing device 4b. The reference sensing device 4a and the target sensing device 4b are disposed apart from each other along the road 6. A sensing range P of the reference sensing device 4a and a sensing range Q of the target sensing device 4b overlap each other. In FIG. 3, a sensing overlapping region R of the sensing range P and the sensing range Q is indicated by hatching. The sensing overlapping region R is a specific example of the target object for which surveying reliability is ensured. A difference between the reference sensing device 4a and the target sensing device 4b is as follows.

The reference sensing device 4a is a sensing device for which the surveying reliability is ensured. Ensuring the surveying reliability of the reference sensing device 4a means ensuring the surveying reliability of a position and a pose of the reference sensing device 4a. Here, the position and the pose of the reference sensing device 4a are the position and the pose of the reference sensing device 4a expressed in the geographic coordinate system. By periodically surveying the position and the pose of the reference sensing device 4a, the surveying reliability of the position and the pose of the reference sensing device 4a is ensured. Since the position and the pose of the reference sensing device 4a are inevitably changed over time, the position and the pose of the reference sensing device 4a are naturally deviated from the design values. Accordingly, it can be said that the surveying reliability of the position and the pose of the reference sensing device 4a is ensured, that is, deviation amounts from the design values of the position and the pose of the reference sensing device 4a are accurately measured.

Meanwhile, the target sensing device 4b is a sensing device for which the surveying reliability is not ensured. That is, the surveying reliability of the position and the pose of the target sensing device 4b is not ensured. Therefore, the deviation amounts from the design values of the position and the pose of the target sensing device 4b are not measured yet.

The reference sensing device 4a outputs the three-dimensional point cloud generated by distance measurement to the road monitoring device 2 as a reference sensing point cloud. The target sensing device 4b outputs the three-dimensional point cloud generated by distance measurement to the road monitoring device 2 as a target sensing point cloud.

Accordingly, the road monitoring system 1 calibrates the position and the pose of the target sensing device 4b as described below. Typically, the deviation amounts from the design values of the position and the pose of the target sensing device 4b are calculated, or output data of the target sensing device 4b is appropriately corrected using a calculated deviation amount.

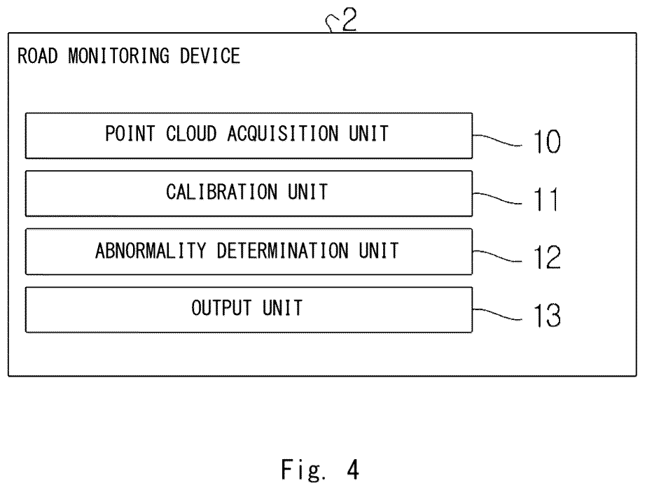

FIG. 4 illustrates a block diagram of the road monitoring device 2. The road monitoring device 2 is a specific example of the calibration device. As illustrated in FIG. 4, the road monitoring device 2 includes a point cloud acquisition unit 10, a calibration unit 11, an abnormality determination unit 12, and an output unit 13.

The point cloud acquisition unit 10 acquires the reference sensing point cloud from the reference sensing device 4a, and acquires the target sensing point cloud from the target sensing device 4b.

The calibration unit 11 calibrates the position and the pose of the target sensing device 4b based on the reference sensing point cloud and the target sensing point cloud. Specifically, the calibration unit 11 calibrates the position and the pose of the target sensing device 4b based on a comparison result obtained by comparing the reference sensing point cloud with the target sensing point cloud. The comparison result obtained by comparing the reference sensing point cloud with the target sensing point cloud is a registration result obtained by registering the reference sensing point cloud and the target sensing point cloud.

As a method of registering the reference sensing point cloud and the target sensing point cloud, iterative closest point (ICP) is known. The ICP is a technology for deriving a relative positional relationship between a LiDAR coordinate system of the reference sensing point cloud and a LiDAR coordinate system of the target sensing point cloud by associating the reference sensing point cloud with the target sensing point cloud. Specifically, in the ICP, a rigid body transformation matrix for transforming the LiDAR coordinate system of the reference sensing point cloud into the LiDAR coordinate system of the target sensing point cloud is generated. The rigid body transformation matrix is a specific example of the comparison result and the registration result.

The calibration unit 11 executes two-stage registration processing of coarse adjustment and fine adjustment from the viewpoint of speeding up the registration processing by the ICP. In the coarse adjustment, the calibration unit 11 generates an initial condition for the registration of the reference sensing point cloud and the target sensing point cloud based on the design values of the position and the pose of the reference sensing device 4a and the target sensing device 4b. Instead, in the coarse adjustment, the calibration unit 11 may generate the initial condition of the registration of the reference sensing point cloud and the target sensing point cloud based on an own position estimated by an own position estimation means mounted on the reference sensing device 4a and the target sensing device 4b. The own position estimation means is typically a global navigation satellite system (GNSS) module. Examples of the GNSS module include a global positioning system (GPS) module, a global navigation satellite system (GLONASS) module, a Galileo module, a BeiDou module, and a quasi-zenith satellite system (QZSS) module. In the fine adjustment, the calibration unit 11 registers the reference sensing point cloud and the target sensing point cloud by the ICP.

From the viewpoint of speeding up the registration processing by the ICP, the calibration unit 11 may extract a point cloud advantageous for the ICP from the reference sensing point cloud and the target sensing point cloud, and register the extracted point clouds. Here, for the ICP, the calibration unit 11 extracts a point cloud relevant to a structurally characteristic object such as a utility pole, a signboard, or a curbstone installed on the road 6 or a white line that can be identified by luminance. Accordingly, the calibration unit 11 can typically use feature point extraction based on Harris 3D or fast point feature histograms (FPFH).

From the viewpoint of speeding up the registration processing by the ICP, the calibration unit 11 may search for and identify the sensing overlapping region R based on the design values of the position and the pose of the reference sensing device 4a and the target sensing device 4b, extract a point cloud to which the sensing overlapping region R belongs from the reference sensing point cloud and the target sensing point cloud, and register the extracted point clouds.

Then, the calibration unit 11 calibrates the position and the pose of the target sensing device 4b using the rigid body transformation matrix. Specifically, the position and the pose of the reference sensing device 4a are accurately measured by surveying, and the positional relationship between the LiDAR coordinate system of the reference sensing device 4a and the LiDAR coordinate system of the target sensing device 4b is obtained by the rigid body transformation matrix. Accordingly, the position and the pose of the target sensing device 4b can be obtained with substantially the same accuracy as the position and the pose of the reference sensing device 4a. That is, the deviation amounts from the design values of the position and the pose of the target sensing device 4b can be obtained with high accuracy. The calibration unit 11 generates a calibration transformation matrix indicating the deviation amounts.

A timing at which the calibration unit 11 executes the above calibration typically includes a periodic timing, a timing immediately after occurrence of an earthquake, and a timing instructed by an operator of the road monitoring device 2. The timing may be a timing at which the degree of matching between two different target sensing point clouds on a time axis falls below a predetermined value while monitoring the target sensing point cloud output from the target sensing device 4b. That is, the timing of the calibration can be determined based on the rigid body transformation matrix obtained by registering two different target sensing point clouds on the time axis.

The abnormality determination unit 12 determines presence of an abnormality of the road 6 based on the target sensing point cloud. The abnormality of the road 6 is typically foreign matters present on the road surface of the road 6 and a local bulge or depression of the road 6. The abnormality determination unit 12 can determine presence or absence of the abnormality of the road 6 using, for example, PointNet. The abnormality determination unit 12 may detect the foreign matters present on the road surface of the road 6 as abnormalities by detecting the road surface of the road 6 and detecting a point cloud deviating upward from the road surface by a distance equal to or more than a predetermined distance. In a case where the abnormality of the road 6 is detected, the abnormality determination unit 12 transforms a position of the abnormality into a geographic coordinate system and outputs the geographic coordinate system to the output unit 13. For the transformation of the position of the abnormality into the geographic coordinate system by the abnormality determination unit 12, the position and the pose of the target sensing device 4b are calibrated by applying the calibration transformation matrix generated by the calibration unit 11 to the position and the pose of the target sensing device 4b, and coordinate transformation is performed on the position of the abnormality expressed in the LiDAR coordinate system of the target sensing device 4b into the geographic coordinate system based on the calibrated position and pose of the target sensing device 4b.

In a case where the abnormality determination unit 12 detects the abnormality of the road 6, the output unit 13 outputs an abnormality avoidance command to one or a plurality of vehicles traveling near the abnormality. Typically, the abnormality avoidance command includes the position of the abnormality expressed in the geographic coordinate system. The vehicle executes autonomous avoidance control based on a comparison result obtained by comparing an own position of the vehicle with the position of the abnormality. The output unit 13 may perform notification to an administrator of the road 6 in addition to output of the abnormality avoidance command to the one or a plurality of vehicles traveling near the abnormality.

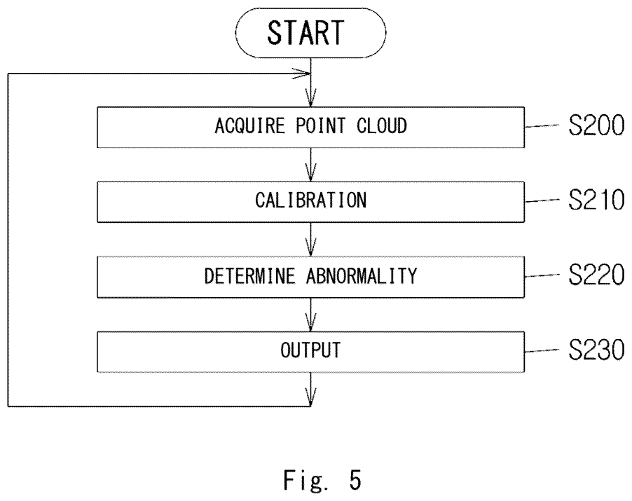

Next, an operation of the road monitoring device 2 will be described. FIG. 5 is an operation flow of the road monitoring device 2.

As illustrated in FIG. 5, first, the point cloud acquisition unit 10 acquires the reference sensing point cloud from the reference sensing device 4a, and acquires the target sensing point cloud from the target sensing device 4b (S200). Next, the calibration unit 11 calibrates the position and the pose of the target sensing device 4b based on the reference sensing point cloud and the target sensing point cloud (S210). Next, the abnormality determination unit 12 determines the presence of the abnormality of the road 6 based on the target sensing point cloud (S220). In a case where the abnormality determination unit 12 detects the abnormality of the road 6, the output unit 13 outputs the abnormality avoidance command to the one or a plurality of vehicles traveling near the abnormality (S230).

The first example embodiment of the present disclosure has been described above, and the first example embodiment has the following features.

The road monitoring system 1 (calibration system) includes the point cloud acquisition unit 10 (point cloud acquisition means) for acquiring the target sensing point cloud from the target sensing device 4b that measures the distance from the sensing overlapping region R (target object for which surveying reliability is ensured), and the calibration unit 11 (calibration means) for calibrating the position and the pose of the target sensing device 4b based on the target sensing point cloud. According to the above configuration, it is possible to calibrate the position and the pose of the target sensing device 4b.

The target object for which the surveying reliability is ensured is the sensing overlapping region R (target object) of which the distance can be measured by the reference sensing device 4a for which the surveying reliability is ensured. The point cloud acquisition unit 10 acquires the reference sensing point cloud generated by the reference sensing device 4a by measuring the distance from the sensing overlapping region R. The calibration unit 11 calibrates the position and the pose of the target sensing device 4b based on the comparison result obtained by comparing the reference sensing point cloud with the target sensing point cloud. According to the above configuration, as long as the reference sensing device 4a and the target sensing device 4b can measure the distance from the common sensing overlapping region R, the position and the pose of the target sensing device 4b can be calibrated even in a case where the reference sensing device 4a and the target sensing device 4b are far apart from each other.

The target object for which the surveying reliability is ensured is the sensing overlapping region R (overlapping region) where the sensing range of the reference sensing device 4a and the sensing range of the target sensing device 4b overlap each other. According to the above configuration, the position and the pose of the target sensing device 4b can be calibrated even in a case where the reference sensing device 4a and the target sensing device 4b are far apart from each other.

The comparison result obtained by comparing the reference sensing point cloud with the target sensing point cloud is the registration result obtained by registering the reference sensing point cloud and the target sensing point cloud. According to the above configuration, the position and the pose of the target sensing device 4b can be calibrated using the known ICP.

### Second Example Embodiment

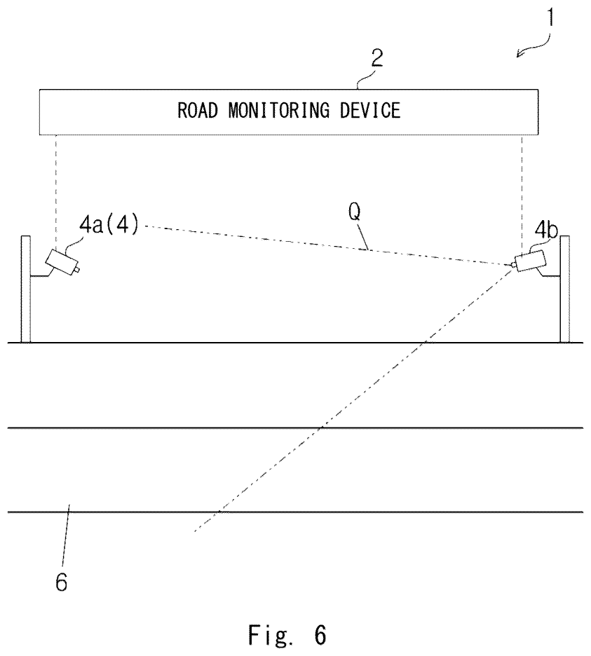

Next, a second example embodiment of the present disclosure will be described. Hereinafter, differences between the first example embodiment and the present example embodiment will be mainly described, and repeated description thereof will be omitted. FIG. 6 is a schematic diagram of the road monitoring system 1.

As illustrated in FIG. 6, in the present example embodiment, the reference sensing device 4a is within the sensing range Q of the target sensing device 4b. That is, the target sensing device 4b can generate a point cloud relevant to the reference sensing device 4a by measuring the distance from the reference sensing device 4a. In the present example embodiment, the target object for which the surveying reliability is ensured is the reference sensing device 4a itself for which the surveying reliability is ensured.

Then, the calibration unit 11 calibrates the position and the pose of the target sensing device 4b based on the target sensing point cloud. Specifically, the calibration unit 11 registers the point cloud of the reference sensing device 4a in a case where it is assumed that the position and the pose of the target sensing device 4b match the design values, and the target sensing point cloud acquired by the point cloud acquisition unit 10 in the calibration. Accordingly, the deviation amounts from the design values of the position and the pose of the target sensing device 4b can be obtained with high accuracy. That is, the calibration unit 11 can generate the calibration transformation matrix indicating the deviation amounts. The point cloud of the reference sensing device 4a in a case where it is assumed that the position and the pose of the target sensing device 4b match the design values can be typically generated using CAD data of the reference sensing device 4a.

The second example embodiment has been described above, and the second example embodiment has the following features.

That is, the target object for which the surveying reliability is ensured is the reference sensing device 4a itself for which the surveying reliability is ensured. According to the above configuration, it is possible to calibrate the position and the pose of the target sensing device 4b even in a case where it is difficult to register a reference sensing point cloud and a reference sensing point cloud by the ICP due to a wide bulge or the like on the road surface of the road 6.

### Third Example Embodiment

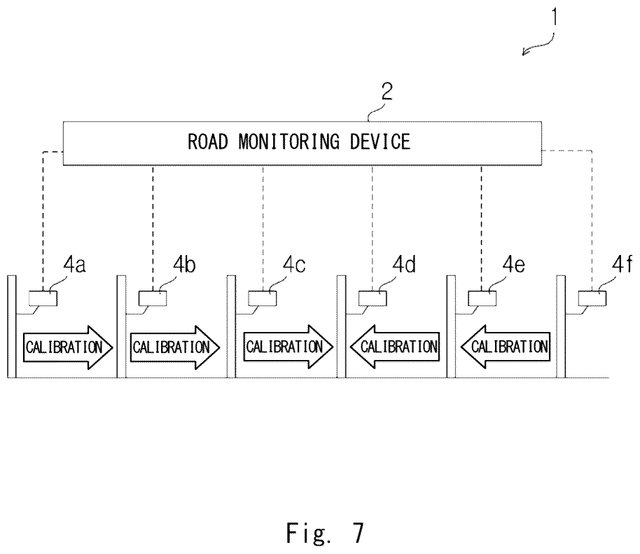

Next, a third example embodiment of the present disclosure will be described. Hereinafter, differences between the first example embodiment and the present example embodiment will be mainly described, and repeated description thereof will be omitted. FIG. 7 is a schematic diagram of the road monitoring system 1.

As illustrated in FIG. 7, in the present example embodiment, the plurality of fixed point observation devices 4 include a sensing device 4a, a sensing device 4b, a sensing device 4c, a sensing device 4d, a sensing device 4e, and a sensing device 4f. Each of the sensing device 4a and the sensing device 4f is relevant to a reference sensing device that is a sensing device for which the surveying reliability is ensured. Each of the sensing devices 4b to 4e is relevant to a target sensing device that is a sensing device for which the surveying reliability is not ensured.

In the first example embodiment and the second example embodiment, the position and the pose of the sensing device 4b are calibrated with reference to the sensing device 4a. Meanwhile, the road monitoring device 2 according to the present example embodiment further calibrates the position and the pose of the sensing device 4c with reference to the sensing device 4b, and calibrates the position and the pose of the sensing device 4d with reference to the sensing device 4c. However, in a case where the calibration is repeated as such, unavoidable errors are accumulated in the registration, and thus, it is difficult to expect high calibration accuracy of the position and the pose of fixed point observation devices 4 on a downstream side. Accordingly, in the example of FIG. 7, the calibration of the position and the pose of the sensing device 4d and the sensing device 4e may be executed with reference to the sensing device 4f. That is, the position and the pose of the sensing device 4e can be calibrated with reference to the sensing device 4f, and the position and the pose of the sensing device 4d can be calibrated with reference to the sensing device 4e. As described above, in a case where the position and the pose of the plurality of fixed point observation devices 4 are calibrated, it is conceivable to select a reference sensing device for each fixed point observation device 4 in such a way that the accumulated number of the calibration from the reference sensing device is as small as possible.

### Fourth Example Embodiment

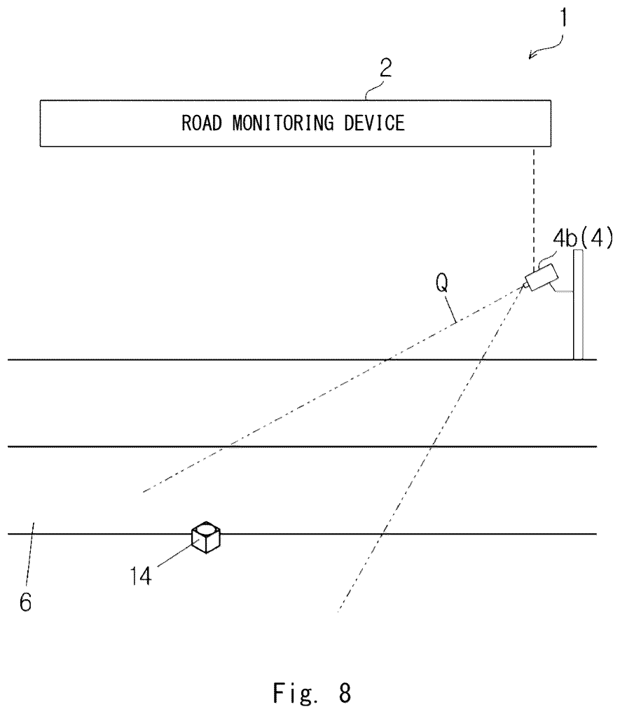

Next, a fourth example embodiment of the present disclosure will be described. Hereinafter, differences between the second example embodiment and the present example embodiment will be mainly described, and repeated description thereof will be omitted. FIG. 8 is a schematic diagram of the road monitoring system 1.

As illustrated in FIG. 8, in the present example embodiment, a reference point sign 14 for which the surveying reliability is ensured is within the sensing range Q of the target sensing device 4b. That is, the target sensing device 4b can generate the point cloud relevant to the reference point sign 14 by measuring the distance from the reference point sign 14. In the present example embodiment, the target object for which the surveying reliability is ensured is the reference point sign 14 for which the surveying reliability is ensured. Typically, the reference point sign 14 is a triangular point or a level point.

Then, the calibration unit 11 calibrates the position and the pose of the target sensing device 4b based on the target sensing point cloud. Specifically, the calibration unit 11 registers the point cloud of the reference point sign 14 in a case where it is assumed that the position and the pose of the target sensing device 4b match the design values, and the target sensing point cloud acquired by the point cloud acquisition unit 10 in the calibration. Accordingly, the deviation amounts from the design values of the position and the pose of the target sensing device 4b can be obtained with high accuracy. That is, the calibration unit 11 can generate the calibration transformation matrix indicating the deviation amounts. The point cloud of the reference point sign 14 in a case where it is assumed that the position and the pose of the target sensing device 4b match the design values can be typically generated using CAD data of the reference point sign 14.

The fourth example embodiment has been described above, and the fourth example embodiment has the following features.

That is, the target object for which the surveying reliability is ensured is the reference point sign 14 for which the surveying reliability is ensured. According to the above configuration, the position and the pose of the target sensing device 4b can be calibrated even in a case where it is difficult to register a reference sensing point cloud and a reference sensing point cloud by the ICP due to scattering of a large amount of the foreign matters on the road 6 or the like.

The fourth example embodiment can be modified as follows. That is, instead of the reference point sign 14 for which the surveying reliability is ensured, another structure for which the surveying reliability is ensured may be used. As an example, the surveying reliability of the structure is ensured by surveying using the reference point sign 14 for which the surveying reliability is ensured. In a case where the structure has a rectangular parallelepiped shape or a cube shape, the pose of the target sensing device 4b may be calibrated using an edge of the structure.

### Example of Hardware Configuration

Hereinafter, a case where each functional component of the road monitoring device 2 is implemented in a combination of hardware and software will be described.

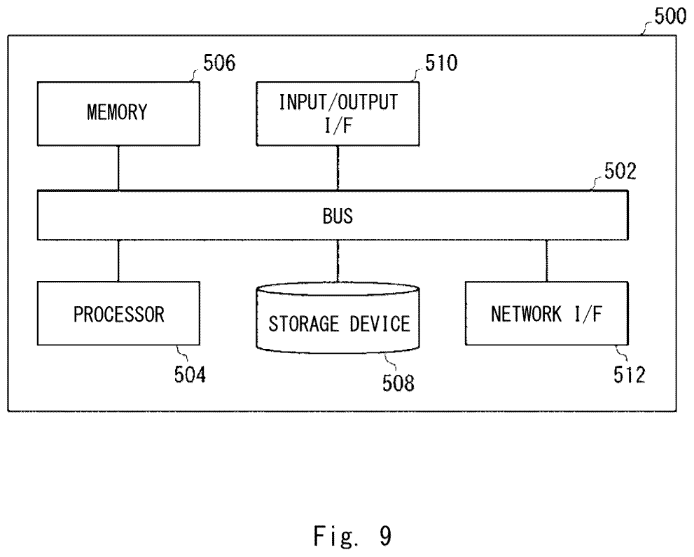

FIG. 9 is a block diagram illustrating a hardware configuration of a computer. The device according to the present disclosure can implement the above-described functions by a computer 500 that has the hardware configuration illustrated in FIG. 9. The computer 500 may be a portable computer such as a smartphone or a tablet terminal, or may be a stationary computer such as a PC.

The computer 500 may be a dedicated computer designed to implement each of the devices, or a general-purpose computer. The computer 500 can implement a relevant function by installing a predetermined program.

The computer 500 includes a bus 502, a processor 504, a memory 506, a storage device 508, an input/output interface 510 (an interface is also referred to as an interface (I/F)), and a network interface 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is any of various processors such as a CPU, a GPU, and an FPGA. The memory 506 is a primary storage device achieved by using a random access memory (RAM) or the like.

The storage device 508 is an auxiliary storage device implemented using a hard disk, an SSD, a memory card, a read only memory (ROM), or the like. The storage device 508 stores a program for implementing a predetermined function. The processor 504 reads the program into the memory 506 and executes the program to achieve each functional component of each of the devices.

The input/output interface 510 is an interface for connecting the computer 500 and an input/output device. For example, an input device such as a keyboard and an output device such as a display device are connected to the input/output interface 510.

The network interface 512 is an interface for connecting the computer 500 to a network.

Although the example of the hardware configuration in the disclosure has been described above, the above-described example embodiments are not limited here. The disclosure can also be implemented by causing a processor to execute a computer program.

In the above-described example, the program includes instructions (or software codes) for causing a computer to perform one or a plurality of functions described in the example embodiments in a case of being read by the computer. The program may be stored in a non-transitory computer-readable medium or a tangible storage medium. As an example and not by way of limitation, computer-readable media or tangible storage media include a random-access memory (RAM), a read-only memory (ROM), a flash memory, a solid-state drive (SSD) or other memory technologies, a CD-ROM, a digital versatile disc (DVD), a Blu-ray (registered trademark) disc or other optical disk storages, a magnetic cassette, a magnetic tape, and a magnetic disk storage or other magnetic storage devices. The program may be transmitted on a transitory computer-readable medium or communication medium. As an example and not by way of limitation, transitory computer-readable media or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Each of the drawings is merely an example to illustrate one or a plurality of example embodiments. Each of the drawings is not associated with only one specific example embodiment, but may be associated with one or a plurality of other example embodiments. As those skilled in the art will appreciate, various features or steps described with reference to any one of the drawings may be combined with features or steps illustrated in one or a plurality of other drawings, for example, to create an example embodiment that is not explicitly illustrated or described. All of the features or the steps illustrated in any one of the drawings for describing illustrative example embodiments are not necessarily essential, and a part of the features or the steps may be omitted. The order of the steps described in any of the drawings may be changed as appropriate.

A part or all of the above example embodiments may also be described as the following Supplementary Notes, but are not limited to the following.

### Supplementary Note 1

A calibration system including:
a point cloud acquisition means for acquiring a target sensing point cloud from a target sensing device that measures a distance from a target object for which surveying reliability is ensured; and
a calibration means for calibrating a position and a pose of the target sensing device based on the target sensing point cloud.

### Supplementary Note 2

The calibration system according to Supplementary Note 1, wherein
the target object is a target object of which a distance is measurable by a reference sensing device for which the surveying reliability is ensured,
the point cloud acquisition means acquires a reference sensing point cloud obtained by the reference sensing device measuring the distance from the target object, and
the calibration means calibrates the position and the pose of the target sensing device based on a comparison result obtained by comparing the reference sensing point cloud with the target sensing point cloud.

### Supplementary Note 3

The calibration system according to Supplementary Note 2, wherein the target object is an overlapping region where a sensing range of the reference sensing device and a sensing range of the target sensing device overlap each other.

### Supplementary Note 4

The calibration system according to Supplementary Note 2, wherein the comparison result obtained by comparing the reference sensing point cloud with the target sensing point cloud is a registration result obtained by registering the reference sensing point cloud and the target sensing point cloud.

### Supplementary Note 5

The calibration system according to Supplementary Note 1, wherein the target object is a reference sensing device itself for which the surveying reliability is ensured.

### Supplementary Note 6

The calibration system according to Supplementary Note 1, wherein the target object is a structure for which the surveying reliability is ensured or a reference point sign for which the surveying reliability is ensured.

### Supplementary Note 7

The calibration system according to Supplementary Note 1, further including:
an abnormality determination means for determining an abnormality based on the target sensing point cloud; and
an output means for outputting a determination result by the abnormality determination means.

### Supplementary Note 8

A calibration device including:
a point cloud acquisition means for acquiring a target sensing point cloud from a target sensing device that measures a distance from a target object for which surveying reliability is ensured; and
a calibration means for calibrating a position and a pose of the target sensing device based on the target sensing point cloud.

### Supplementary Note 9

A calibration method causing a computer to execute:
acquiring a target sensing point cloud from a target sensing device that measures a distance from a target object for which surveying reliability is ensured; and
calibrating a position and a pose of the target sensing device based on the target sensing point cloud.

### Supplementary Note 10

A program causing a computer to operate as:
a point cloud acquisition means for acquiring a target sensing point cloud from a target sensing device that measures a distance from a target object for which surveying reliability is ensured; and
a calibration means for calibrating a position and a pose of the target sensing device based on the target sensing point cloud.

A part or all of the elements (for example, configurations and functions) described in Supplementary Notes 2 to 7 dependent on Supplementary Note 1 can also depend on Supplementary Notes 8 to 10 in the same dependency relationship as that of Supplementary Notes 2 to 7. A part or all of the elements described in any Supplementary Note may be applied to various types of hardware, software, recording means for recording software, systems, and methods.

1. A calibration system comprising:
at least one memory storing computer-executable instructions; and
at least one processor configured to access the at least one memory and execute the computer-executable instructions to:
acquire a target sensing point cloud from a target sensing device that measures a distance from a target object for which surveying reliability is ensured; and
calibrate a position and a pose of the target sensing device based on the target sensing point cloud.

2. The calibration system according to claim 1, wherein
the target object is a target object of which a distance is measurable by a reference sensing device for which the surveying reliability is ensured, and
wherein the at least one processor is further configured to execute the instructions to:
acquire a reference sensing point cloud obtained by the reference sensing device measuring the distance from the target object, and
calibrate the position and the pose of the target sensing device based on a comparison result obtained by comparing the reference sensing point cloud with the target sensing point cloud.

3. The calibration system according to claim 2, wherein the target object is an overlapping region where a sensing range of the reference sensing device and a sensing range of the target sensing device overlap each other.

4. The calibration system according to claim 2, wherein the comparison result obtained by comparing the reference sensing point cloud with the target sensing point cloud is a registration result obtained by registering the reference sensing point cloud and the target sensing point cloud.

5. The calibration system according to claim 1, wherein the target object is a reference sensing device itself for which the surveying reliability is ensured.

6. The calibration system according to claim 1, wherein the target object is a structure for which the surveying reliability is ensured or a reference point sign for which the surveying reliability is ensured.

7. The calibration system according to claim 1, wherein the at least one processor is further configured to execute the instructions to determine an abnormality based on the target sensing point cloud and output a determination result.

8. A calibration device comprising:
at least one memory storing computer-executable instructions; and
at least one processor configured to access the at least one memory and execute the computer-executable instructions to:
acquire a target sensing point cloud from a target sensing device that measures a distance from a target object for which surveying reliability is ensured; and
calibrate a position and a pose of the target sensing device based on the target sensing point cloud.

9. A computer-implemented calibration method being performed by at least one processor executing stored instructions to perform steps comprising:
acquiring a target sensing point cloud from a target sensing device that measures a distance from a target object for which surveying reliability is ensured; and
calibrating a position and a pose of the target sensing device based on the target sensing point cloud.
